(19) United States
(12) Patent Application Publication
(10) Pub. No.: US 2008/0284690 A1
(43) Pub. Date: Nov. 20, 2008

(54) ORGANIC LIGHT EMITTING DISPLAY DEVICE

(76) Inventors: Sam Min Ko, Jinpyoung-dong Gumi-city (KR); Seung Ho Kwon, Jinpyoung-dong Gumi-city (KR)

Correspondence Address: KED & ASSOCIATES, LLP, P.O. Box 221200, Chantilly, VA, 20153-1200, US

(21) Appl. No.: 12/122,222

(22) Filed: May 16, 2008

Related U.S. Application Data
(60) Provisional application No. 60/938,730, filed on May 18, 2007.

(51) Int. Cl. G09G 3/30

(52) U.S. Cl. 345/76

(57) ABSTRACT

Disclosed is an organic light emitting display device. The exemplary organic light emitting display device according to an exemplary embodiment of the present invention comprises a substrate, a displaying area located on the substrate, the displaying area comprising a plurality of sub pixels, each of which has an emission area; and a dummy area located on an area of the substrate other than the displaying area, the dummy area comprising a plurality of dummy patterns, wherein the dummy pattern contains the same material as that of the emission area.

This application claims the benefit of U.S. Provisional Application No. 60/938,730 filed May 18, 2007, whose entire disclosure is incorporated herein by reference.

### BACKGROUND

1. Field

This document is related to an organic light emitting display device.

2. Related Art

Organic light emitting display (“OLED”) devices show a faster response time and lower power consumption over other flat display devices. Also, an OLED device requires no backlight to function, which enables the OLED device to be made thin and light.

An OLED device comprises an anode electrode, a cathode electrode, and an emission area that is arranged between the anode electrode and the cathode electrode and has an organic light emitting layer. A hole from the anode electrode and an electron from the cathode electrode are combined into each other in the organic light emitting layer to create a hole-electron pair, i.e. “exciton”. The emission area emit light by energy generated when the exciton returns from its excited state to its ground state.

The emission area may comprise hole injection/transportation layers and/or electron injection/transportation layers that are located over and under an organic light emitting layer to help the transportation of holes and electrons. The thickness of each layer may be determined to facilitate the transportation of holes and electrons and improve the emission efficiency.

### SUMMARY

An aspect of this document is to provide an organic light emitting display device comprising: a substrate; a displaying area located on the substrate, the displaying area comprising a plurality of sub pixels, each of which has an emission area; and a dummy area located on an area of the substrate other than the displaying area, the dummy area comprising a plurality of dummy patterns, wherein the dummy pattern contains the same material as that of the emission area.

An aspect of this document is to provide an organic light emitting display device comprising: a substrate; a displaying area located on the substrate, the displaying area comprising a plurality of sub pixels, each of which has an emission area; a dummy area located on an area of the substrate other than the displaying area, the dummy area comprising a plurality of dummy patterns; and a monitoring area located outside the displaying area, the monitoring area comprising a plurality of monitoring pixels.

### BRIEF DESCRIPTION OF THE DRAWINGS

The implementation of this document will be described in detail with reference to the following drawings in which like numerals refer to like elements.

FIG. 1 is a plan view illustrating an OLED device according to an exemplary embodiment of the present invention.

FIG. 2 is an expanded view of area A illustrated in FIG. 1.

FIG. 3 is a cross sectional view taken along line I-I′ of FIG. 2.

FIG. 4 is a plan view illustrating an OLED device according to an exemplary embodiment of the present invention.

FIG. 5 is an expanded view of area B illustrated in FIG. 4.

FIG. 6 is a cross sectional view taken along line II-II′ of FIG. 5.

### DETAILED DESCRIPTION

Hereinafter, an implementation of this document will be described in detail with reference to the attached drawings.

According to an exemplary embodiment of the present invention, an organic light emitting display device is provided, which may comprise: a substrate; a displaying area located on the substrate, the displaying area comprising a plurality of sub pixels, each of which has an emission area; and a dummy area located on an area of the substrate other than the displaying area, the dummy area comprising a plurality of dummy patterns, wherein the dummy pattern contains the same material as that of the emission area.

The dummy pattern may comprise a dummy layer.

The dummy layer may be formed of the same material as that of any one or more than one of layers constituting the emission area.

The dummy layer may be an organic layer or an inorganic layer.

Two and more of the dummy patterns may comprise different layers.

The dummy layer may comprise the same thickness as that of any one layer of the emission area.

The dummy pattern may be substantially equal in size to the sub pixel.

The dummy pattern may be substantially 1 time to substantially 3 times in size of the sub pixel.

The organic light emitting display device may further comprise: an insulating layer located between the substrate and the dummy pattern.

According to an exemplary embodiment of the present invention, an organic light emitting display device is provided, which may comprise: a substrate; a displaying area located on the substrate, the displaying area comprising a plurality of sub pixels, each of which has an emission area; a dummy area located on an area of the substrate other than the displaying area, the dummy area comprising a plurality of dummy patterns; and a monitoring area located outside the displaying area, the monitoring area comprising a plurality of monitoring pixels.

The monitoring pixel may comprise a first insulating layer, a shield metal layer arranged on the first insulating layer, a second insulating layer arranged on the shield metal layer, a first electrode arranged on the second insulating layer, an emission area arranged on the first electrode, and a second electrode arranged on the emission area.

The dummy pattern may comprise a reflective metal film and a dummy layer.

The dummy layer may be formed of the same material as that of any one or more than one of layers constituting the emission area.

The dummy layer may be an organic layer or an inorganic layer.

Two and more of the dummy patterns may comprise different layers.

The dummy layer may comprise the same thickness as that of any one layer of the emission area.

The dummy pattern may be substantially equal in size to the sub pixel.

The dummy pattern may be substantially 1 time to substantially 3 times in size of the sub pixel.

The organic light emitting display device may further comprise: an insulating layer located between the substrate and the dummy pattern.

The dummy pattern may contain the same material as that of the emission area.

Hereinafter, exemplary embodiments of the present invention will be described in more detail with reference to accompanying drawings.

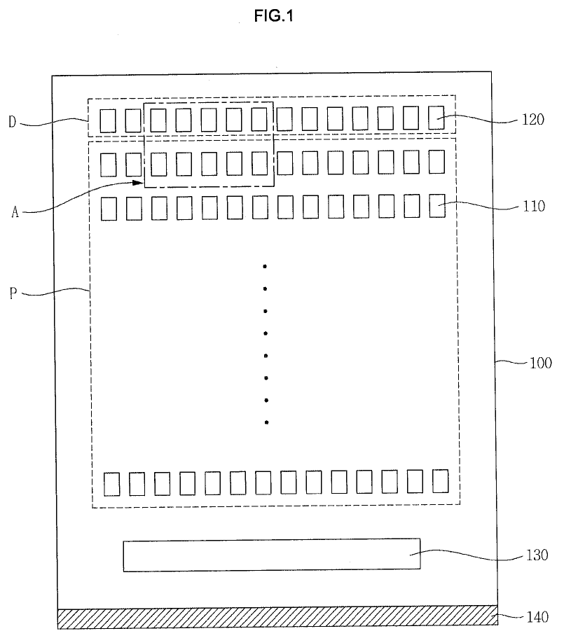

FIG. 1 is a plan view illustrating an OLED device according to an exemplary embodiment of the present invention.

Referring to FIG. 1, the OLED device comprises a displaying area P located on a substrate 100 to display an image. The substrate 100 comprises an emission area and a non-emission area. The emission area is defined as the displaying area P, and the non-emission area is defined as the other areas than the displaying area P.

The displaying area P comprises a plurality of sub pixels 110 arranged in a matrix pattern. Each sub pixel 110 may comprise a light emitting diode (LED) that comprises a first electrode, an emission area, and a second electrode. The emission area comprises at least one organic light emitting layer. The emission area may further comprise a hole injection/transportation layer and/or an electron injection/transportation layer arranged over and under the organic light emitting layer to facilitate the transportation of holes and/or electrons, respectively. The first electrode or the second electrode may be an anode or a cathode that supplies the organic light emission layer with electrons or holes. The sub pixel 110 may further comprise a thin film transistor (TFT) electrically connected to the first electrode.

A dummy area D is located on the non-emission area of the substrate 100. The dummy area D comprises a plurality of dummy patterns 120, each of which may comprise a dummy layer. The dummy layer may contain the same material as that contained in any one or more than one of the layers constituting the emission area of the sub pixel 110. At least two and more dummy pattern may comprise different layers each other. For example, some dummy pattern may comprise an organic layer formed of the same material as that of the hole transportation layer, and other dummy pattern may comprise an inorganic layer formed of the same material as that of the electron injection layer. Accordingly, the dummy layer may be formed in the same process as that of one or more layers comprised in the emission area of the sub pixel 110. The dummy layer may comprise the same thickness as one or more layers comprised in the emission area of the sub pixel 110.

Each dummy pattern 120 may be substantially equal in size to the sub pixel 110. Since the dummy pattern comprises the organic layer formed of the same material in the same process as one or more layers comprised in the emission area of the sub pixel 110, the thickness of any one layer comprised in the emission area of the sub pixel 110 may be known by measuring the thickness of the organic layer in the dummy pattern. In other words, the dummy pattern is provided as a pattern for measurement to evaluate the precision and accuracy of the manufacturing processes for the OLED device, and therefore, the dummy pattern may be formed to be substantially equal in size to the sub pixel 110 to raise the reliability in measurement.

The size of each dummy pattern 120 may be about 1 time to about three times of that of the sub pixel 110. Every layer constituting the emission area of the sub pixel 110 may be deposited using a shadow mask. The shadow mask comprises an open area and a solid area. The open area is formed to correspond to a part of the sub pixel and the dummy pattern upon forming the emission area. Accordingly, since a part of the open area corresponding to the dummy pattern is located outside a part of the open area corresponding to the sub pixel, the part of the open area corresponding to the dummy pattern is located outside the shadow mask. When the emission area is formed using the shadow mask, the shadow mask is stretched to be fixed to a mask frame. Accordingly, in a case where there is an open area comprising the area of about 3 times of the area of the sub pixel around the outmost region of the shadow mask, the shadow mask may become weak in strain, which may cause a misalignment between the substrate and the shadow mask. Therefore, the size of the dummy pattern may be formed to be about 1 time to about 3 times of that of the sub pixel. A drive 130 that supplies an electric signal to the displaying area P and a pad area 140 that transfers an external electric signal to the driver 130 are arranged on the non-emission area of the substrate 100. Although not shown in drawings, the sub pixel 110 of the displaying area is connected to the driver 130 and the pad area 140 via an electrical wire, receives an electrical signal from the driver 130 and the pad area 140, and displays an image corresponding to the electrical signal.

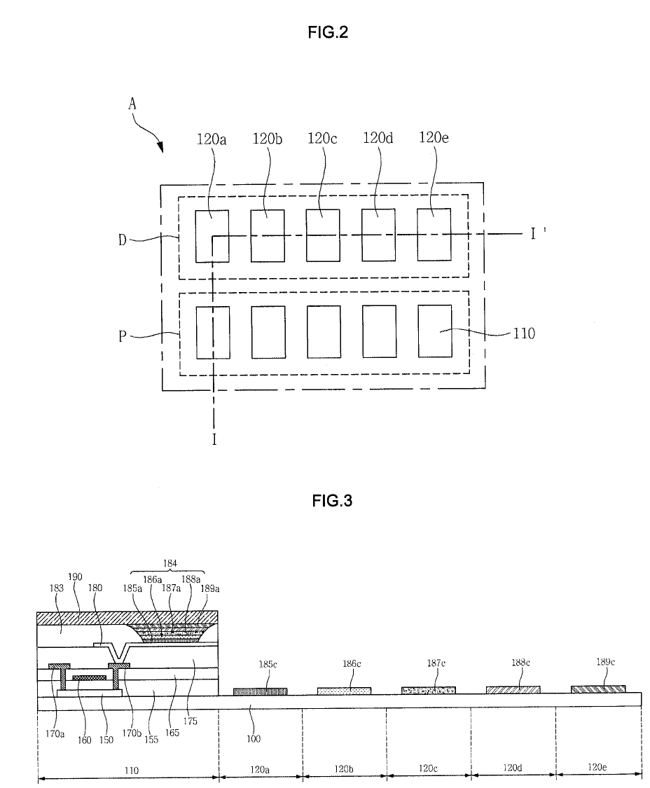

FIG. 2 is an expanded view of area A illustrated in FIG. 1. FIG. 3 is a cross sectional view taken along line I-I′ of FIG. 2. Structures of the sub pixel and the dummy pattern are described below with reference to FIGS. 2 and 3.

Referring to FIGS. 2 and 3, a sub pixel 110 comprises a substrate 100, a semiconductor layer 150, a first insulating layer 155, a gate electrode 160, a second insulating layer 165, a source electrode 170a and a drain electrode 170b, a third insulating electrode 175, a first electrode 180, an emission area 184, and a second electrode 190. The semiconductor layer 150 is arranged on the substrate 100. The first insulating layer 155 is arranged on the semiconductor layer 150. The first insulating layer 155 may be a gate insulating layer. The gate electrode 160 is arranged on the first insulating layer 155 to correspond to the semiconductor layer 150. The second insulating layer 165 is arranged on the gate electrode 160. The source electrode 170a and the drain electrode 170b penetrate the first insulating layer 155 and the second insulating layer 165 to be electrically connected to the semiconductor layer 150. The third insulating layer 175 is arranged on the source electrode 170a and the drain electrode 170b. The first electrode 180 is arranged on the third insulating layer 175 and penetrates the third insulating layer 175 to be electrically connected to the drain electrode 170b. The emission area 184 is arranged on the first electrode 180. The second electrode 190 is arranged on the emission area 184.

A bank layer 183 may be arranged on the first electrode 180 to insulate the first electrode 180 from another first electrode and partially expose the first electrode 180.

The first electrode 180 may be an anode electrode that comprises a transparent conductive oxide film with a high work function. The second electrode 190 may be a cathode electrode that comprises a metal film with a low work function. The first electrode 180 may further comprise a reflective metal film under the transparent conductive oxide film. The second electrode 190 may be a transmissive electrode. Light emanating from the light area is directed toward the second electrode.

The emission area 184 may further comprise at least one organic light emitting layer 187c. The emission area 184 may further comprise a hole injection layer 185a and a hole transportation layer 186a that are arranged between the first electrode 180 and the organic light emitting layer 187c. The emission area 184 may further comprise an electron transportation layer 188a and an electron injection layer 189a that are arranged between the organic light emitting layer 187c and the second electrode 190. The hole injection layer 185a, the hole transportation layer 186a, the electron transportation layer 188a, and the electron injection layer 189a serve to easily supply holes and electrons from the first electrode 180 and the second electrode 190 to the organic light emitting layer 187c to lower the driving voltage necessary for the OLED device.

Each of dummy patterns 120a to 120e may comprise a substrate 100 and each of dummy layers 185c to 189c arranged on the substrate 100, respectively. The dummy layer 185c to 189c may be one or more of the layers constituting the emission area 184 of the sub pixel 110. That is, each of the dummy layers 185c to 189c may be formed of one of an organic layer and an inorganic layer.

At least two of the dummy layers 185c to 189c may contain different materials. The dummy patterns 120a to 120e may comprise any one of the layers constituting the emission area 184.

It is a critical issue to control the thickness of the layers constituting the emission area in the OLED device comprising the sub pixel 110. For example, red, green, and blue materials contained in the organic light emitting layer differ from each other in emission efficiency, and therefore, if the organic light emitting layer fails to comprise a constant thickness, this may alter color coordinates. And, it is necessary to let the layers constituting the emission area comprise the different thickness depending on the color of the sub pixel to achieve resonance effects in an OLED device with a top-emission structure using a micro cavity.

In general, the thickness of the layers constituting the sub pixel 110 may be measured by illuminating the sub pixel 110. More specifically, the thickness may be measured by comparing the polarization of incident light with the polarization of reflective light using a measuring device such as ellipsometer.

As such, the dummy patterns 120a to 120e comprise only the substrate 100 under the dummy layers 184a to 189a unlike the sub pixel 110, and therefore are less affected from reflection or refraction by their lower structures relative to the sub pixel 110. And, since each dummy pattern 120a to 120e comprises any one of the layers constituting the emission area, they are less affected from reflection or refraction by the other layers in comparison with the sub pixel 110 comprising the emission area 184. This may improve the precision and accuracy in measuring the thickness of the dummy layers 185c to 189c, and therefore, the thickness of the emission area 184 comprised in the sub pixel 110 may be easily controlled.

Although not shown, one or more insulating layers may be interposed between the substrate 100 and the semiconductor layer 150 or between the substrate 110 and the dummy layers 184a to 189a. The second electrode 190 may be arranged on the dummy layers 184a to 189a.

As described above, the OLED display according to an exemplary embodiment of the present invention comprises a dummy pattern that has a dummy later with the same material as that of any one of the layers constituting the emission area 184. The dummy pattern has a minimum lower structure comprising the substrate under the dummy pattern. Accordingly, the thickness of every layer comprised in the emission layer may be easily measured by measuring the thickness of the dummy layer upon manufacturing the OLED display, which may improve quality in screen of the OLED display.

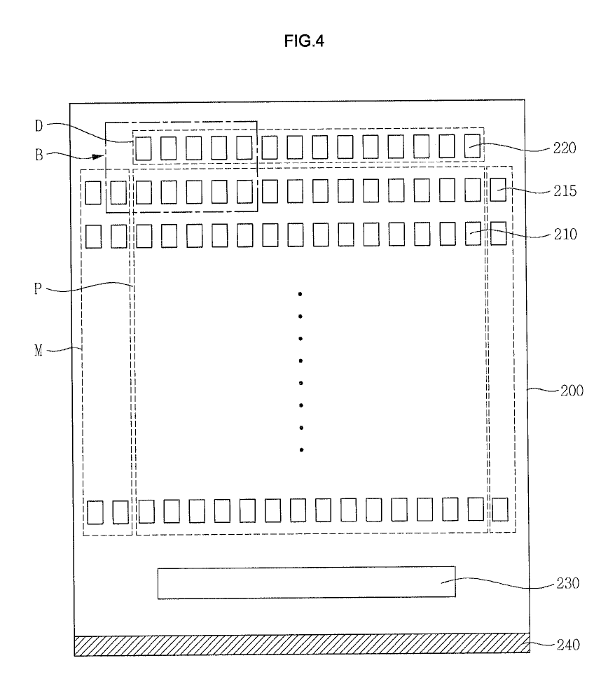

FIG. 4 is a plan view illustrating an OLED device according to an exemplary embodiment of the present invention.

Referring to FIG. 4, the OLED device comprises a displaying area P located on a substrate 200 to display an image. The substrate 200 comprises an emission area and a non-emission area. The emission area is defined as the displaying area P, and the non-emission area is defined as the other areas than the displaying area P.

The displaying area P comprises a plurality of sub pixels 210 arranged in a matrix pattern. Each sub pixel 210 may comprise a light emitting diode (LED) that comprises a first electrode, an emission area, and a second electrode. The emission area comprises at least one organic light emitting layer. The emission area may further comprise a hole injection/transportation layer and/or an electron injection/transportation layer arranged over and under the organic light emitting layer to facilitate the transportation of holes and/or electrons, respectively. The first electrode or the second electrode may be an anode or a cathode that supplies the organic light emission layer with electrons or holes. The sub pixel 210 may further comprise a thin film transistor (TFT) electrically connected to the first electrode.

A dummy area D is located on the non-emission area of the substrate 200. The dummy area D comprises a plurality of dummy patterns 220, each of which may comprise a dummy layer. The dummy layer may be an organic layer or an inorganic layer and contain the same material as that contained in any one or more than one of the layers constituting the emission area of the sub pixel 110. And, at least two or more dummy layers may be formed of different materials. For example, some dummy pattern may comprise a dummy layer formed of the same material as that of the hole transportation layer, and other dummy pattern 220 may comprise a dummy layer formed of the same material as that of the electron injection layer. Accordingly, the dummy pattern 220 may comprise the dummy layer formed in the same process as that of one or more of the layers comprised in the emission area of the sub pixel 210, and the dummy layer may comprise substantially the same thickness as any one of the layers comprised in the emission area of the sub pixel 210.

The dummy pattern is provided as a pattern for measurement to evaluate the precision and accuracy of the manufacturing processes for the OLED device, and therefore, the dummy pattern may be formed to be substantially equal in size to the sub pixel 210 to raise the reliability in measurement.

The size of each dummy pattern, upon forming the emission area by a vacuum evaporation, may be formed to be about 1 time to about 3 times of the size of the sub pixel 210 to prevent a misalignment between the substrate and the shadow mask.

A monitoring area M may be located outside the displaying area P. The emission area of the OLED display comprises an oxygen are infiltrated into the OLED display, the OLED display may be readily deteriorated. And, as the driving time of the OLED display increases, the organic emitting light layer may be readily deteriorated due to heat emanating from a driving device. The emission area may be easily affected by external temperature because of its semiconductor-based characteristics. That is, the amount of current flowing through the light emitting diode may easily vary with the rise and drop in ambient temperature. Accordingly, the magnitude of voltage that needs to be applied to the OLED device so that the OLED device may comprise a constant brightness may be changed depending on the deterioration of the OLED device and the ambient environment, which may make it difficult to allow the OLED device to comprise a constant quality in screen. To compensate for change in the magnitude of voltage caused by the deterioration of the OLED device or temperature, the monitoring area M is provided in the non-emission area outside the displaying area P.

The monitoring area M comprises a plurality of monitoring pixels 215 that are formed in the same process as that of the sub pixel. The monitoring area M receives a direct current (DC) with a constant magnitude for a constant period of time. At this time, the compensation for change in the magnitude of voltage may be carried out by measuring the voltage applied to the monitoring pixel and applying the measured voltage to the sub pixels 210 comprised in the displaying area P.

A driver 230 for applying an electrical signal to the displaying area P and a pad area 240 for transferring an external electrical signal to the driver 230 are arranged on the non-emission area of the substrate. Although not shown in drawings, the sub pixel 210 of the displaying area is connected to the driver 230 and the pad area 240 via an electrical wire, receives an electrical signal from the driver 130 and the pad area 240, and displays an image corresponding to the electrical signal.

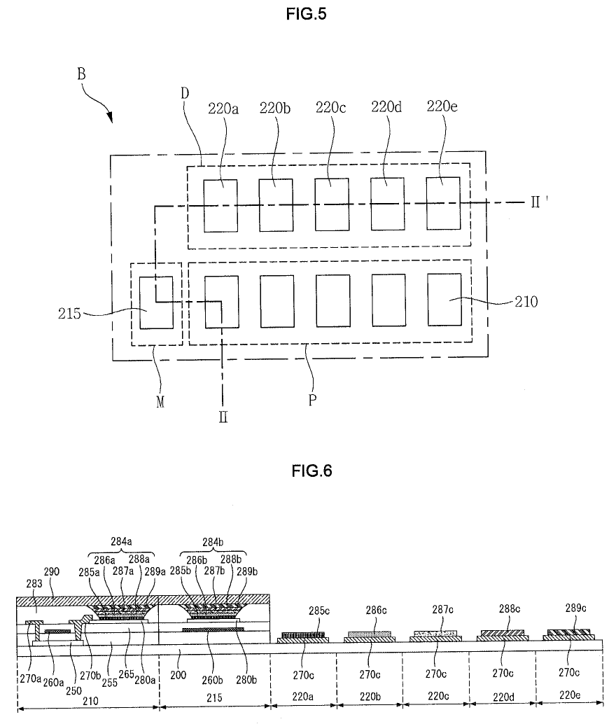

FIG. 5 is an expanded view of area B illustrated in FIG. 4, and FIG. 6 is a cross sectional view taken along line II-II′ of FIG. 5. Structures of the sub pixel and the dummy pattern are described below with reference to FIGS. 5 and 6.

Referring to FIGS. 5 and 6, a sub pixel 210 comprises a substrate 200, a semiconductor layer 250, a first insulating layer 255, a gate electrode 260a, a second insulating layer 265, a source electrode 270a and a drain electrode 270b, a first electrode 280a, an emission area 284a, and a second electrode 290. The semiconductor layer 250 is arranged on the substrate 200. The first insulating layer 255 is arranged on the semiconductor layer 250. The first insulating layer 255 may be a gate insulating layer. The gate electrode 260a is arranged on the first insulating layer 255 to correspond to the semiconductor layer 250. The second insulating layer 265 is arranged on the gate electrode 260a. The source electrode 270a and the drain electrode 270b penetrate the first insulating layer 255 and the second insulating layer 265 to be electrically connected to the semiconductor layer 250. The first electrode 280a is arranged on the second insulating layer 265 and electrically connected to the drain electrode 270b. The emission area 284a is arranged on the first electrode 280a. The second electrode 290 is arranged on the emission area 284a. A bank layer 283 may be arranged on the source electrode 270a, the drain electrode 270b, and the first electrode 280a. The bank layer 283 insulates the first electrode 280a from another first insulating electrode and partially exposes the first electrode 280a.

The first electrode 280a may be an anode electrode that comprises a transparent conductive oxide film with a high work function. The second electrode 290 may be a cathode electrode that comprises a metal film with a low work function. The first electrode 280a may further comprise a reflective metal film under the transparent conductive oxide film. The second electrode 290 may be a transmissive electrode. Light emanating from the light area is directed toward the second electrode.

The emission area 284a may further comprise at least one organic light emitting layer 287c. The emission area 284a may further comprise a hole injection layer 285a and a hole transportation layer 286a that are arranged between the first electrode 280a and the organic light emitting layer 287c. The emission area 284a may further comprise an electron transportation layer 288a and an electron injection layer 289a that are arranged between the organic light emitting layer 287c and the second electrode 290. The hole injection layer 285a, the hole transportation layer 286a, the electron transportation layer 288a, and the electron injection layer 289a serve to easily supply holes and electrons from the first electrode 280a and the second electrode 290 to the organic light emitting layer 287c to lower the driving voltage necessary for the OLED device.

The monitoring pixel 215 comprises a substrate 200, a first insulating layer 255 arranged on the substrate 200, and a shield metal layer 260b arranged on the first insulating layer 255. A second insulating layer 265 is arranged on the shield metal layer 260b, and a first electrode 280b is arranged on the second insulating layer 265. An emission area 284b that comprises a hole injection layer 285b, a hole transportation layer 286b, an organic light emitting layer 287b, an electron transportation layer 288b, and an electron injection layer 289b is arranged on the first electrode 280b. A second electrode 290 is arranged on the emission area 284b. The shield metal layer 260b prevents the external leakage of the light emanating from the monitoring pixel 215 upon applying of a direct current to the monitoring pixel 215.

Each of dummy patterns 220a to 220e may comprise a substrate 200, and a reflective metal film 270c and each of dummy layers 285c to 289c arranged on the substrate 200, respectively. The reflective metal film 270c may contain the same material as that contained in the source electrode 270a and the drain electrode 270b. And, the reflective metal film 270c may be formed in the same process as that contained in the source electrode 270a and the drain electrode 270b. The dummy layer 285c to 289c may be one or more of the layers constituting the emission area 284 of the sub pixel 210. That is, each of the dummy layers 285c to 289c may be formed of one of an organic layer and an inorganic layer.

At least two of the dummy patterns 220a to 220e may comprise dummy layers that contain different materials. The dummy patterns 220a to 220e may comprise any one of the layers constituting the emission area 284a and 284b.

As such, the dummy patterns 220a to 220e comprise only the reflective metal film 270c under the dummy layers 285c to 289c unlike the sub pixel 210, and therefore, are less affected from reflection or refraction by their lower structures relative to the sub pixel 210. And, since each dummy pattern 220a to 220e comprises any one of the layers constituting the emission area, they are less affected from reflection or refraction by the other layers in comparison with the sub pixel 210 comprising the emission area 284. This may improve the precision and accuracy in measuring the thickness of the dummy layers 285c to 289c, and therefore, the thickness of the emission area 284 comprised in the sub pixel 210 may be easily controlled.

Although a case has been described in the above exemplary embodiments, where the reflective metal film 270c is arranged on the substrate 200, the present invention is not limited thereto. For example, the first insulating layer 255 and/or the second insulating layer 265 may be arranged between the substrate 200 and the reflective metal film 270c.

And, an additional insulating layer, e.g. buffer layer, may be arranged between the substrate 200 and the semiconductor layer 250 and between the substrate 200 and the reflective film 270c.

As described above, the OLED display according to an exemplary embodiment of the present invention comprises a dummy pattern that has a dummy later with the same material as that of any one of the layers constituting the emission area 284. And, a reflective metal film is arranged at the lower area of the dummy pattern. Accordingly, the thickness of every layer comprised in the emission layer may be easily measured by measuring the thickness of the dummy layer upon manufacturing the OLED display, which may improve quality in screen of the OLED display.

In a case where the dummy layer comprises an organic layer, the dummy pattern may absorb the moisture infiltrating into the OLED device via the sealants. Accordingly, it can be possible to prevent any damages to sub pixels caused by moisture, thus improving the life span and reliability of the OLED device.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. An organic light emitting display device comprising:
a substrate;
a displaying area located on the substrate, the displaying area comprising a plurality of sub pixels, each of which has an emission area; and
a dummy area located on an area of the substrate other than the displaying area, the dummy area comprising a plurality of dummy patterns, wherein
the dummy pattern contains the same material as that of the emission area.

2. The organic light emitting display device of claim 1, wherein
the dummy pattern comprise a dummy layer.

3. The organic light emitting display device of claim 2, wherein
the dummy layer is formed of the same material as that of any one or more than one of layers constituting the emission area.

4. The organic light emitting display device of claim 2, wherein
the dummy layer is an organic layer or an inorganic layer.

5. The organic light emitting display device of claim 1, wherein
two and more of the dummy patterns comprise different layers each other.

6. The organic light emitting display device of claim 2, wherein
the dummy layer has the same thickness as that of any one layer of the emission area.

7. The organic light emitting display device of claim 1, wherein
the dummy pattern is substantially equal in size to the sub pixel.

8. The organic light emitting display device of claim 1, wherein
the dummy pattern is substantially 1 time to 3 times in size of the sub pixel.

9. The organic light emitting display device of claim 1, further comprising:
an insulating layer located between the substrate and the dummy pattern.

10. An organic light emitting display device comprising:
a substrate;
a displaying area located on the substrate, the displaying area comprising a plurality of sub pixels, each of which has an emission area;
a dummy area located on an area of the substrate other than the displaying area, the dummy area comprising a plurality of dummy patterns; and
a monitoring area located outside the displaying area, the monitoring area comprising a plurality of monitoring pixels.

11. The organic light emitting display device of claim 10, wherein
the monitoring pixel comprises a first insulating layer, a shield metal layer arranged on the first insulating layer, a second insulating layer arranged on the shield metal layer, a first electrode arranged on the second insulating layer, an emission area arranged on the first electrode, and a second electrode arranged on the emission area.

12. The organic light emitting display device of claim 10, wherein
the dummy pattern comprises a reflective metal film and a dummy layer.

13. The organic light emitting display device of claim 12, wherein
the dummy layer is formed of the same material as that of any one or more than one of layers constituting the emission area.

14. The organic light emitting display device of claim 12, wherein
the dummy layer is an organic layer or an inorganic layer.

15. The organic light emitting display device of claim 10, wherein
two and more of the dummy patterns comprise different layers each other.

16. The organic light emitting display device of claim 12, wherein
the dummy layer has the same thickness as that of any one layer of the emission area.

17. The organic light emitting display device of claim 10, wherein
the dummy pattern is substantially equal in size to the sub pixel.

18. The organic light emitting display device of claim 10, wherein
the dummy pattern is substantially 1 time to 3 times in size of the sub pixel.

19. The organic light emitting display device of claim 10, further comprising:
an insulating layer located between the substrate and the dummy pattern.

20. The organic light emitting display device of claim 10, wherein
the dummy pattern contains the same material as that of the emission area.
